(19) United States
(12) Patent Application Publication
(10) Pub. No.: US 2006/0053258 A1
(43) Pub. Date: Mar. 9, 2006

(54) Cache filtering using core indicators

(76) Inventors: Yen-Cheng Liu, Portland, OR (US); Krishnakanth V. Sistla, Hillsboro, OR (US); George Cai, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/936,952

(22) Filed: Sep. 8, 2004

(51) Int. Cl. G06F 12/00

(52) U.S. Cl. 711/145; 711/146

(57) ABSTRACT

A caching architecture within a microprocessor to filter core cache accesses. More particularly, embodiments of the invention relate to a technique to manage transactions, such as snoops, within a processor having a number of processor core caches and an inclusive shared cache.

### FIELD

Embodiments of the invention relate to microprocessors and microprocessor systems. More particularly, embodiments of the invention relate to cache filtering among a number of accesses to one or more processor core caches.

### BACKGROUND

Microprocessors have evolved into multi-core machines that allow a number of software programs to be ran concurrently. A processor “core” typically refers to the logic and circuitry used to decode, schedule, execute, and retire instructions, as well as other circuitry to enable instructions to execute out of program order, such as branch prediction logic. In a multi-core processor, each core typically uses a dedicated cache, such as a level-1 (L1) cache, from which to retrieve more frequently used instructions and data. A core within a multi-core processor may attempt to access data within another core's cache. Furthermore, agents residing on a bus outside of the multi-core processor may attempt to retrieve data from any of the core caches within a multi-core processor.

FIG. 1 illustrates a prior art multi-core processor architecture, including core A, core B, and a their respective dedicated caches, as well as a shared cache that may contain some or all of the data existing within the caches of core A and core B. Typically, an external agent or core attempts to retrieve data from a cache, such as a core cache, by first checking (“snooping”) to see if the data resides in a particular cache. The data may or may not exist within the snooped cache, but the snoop cycle promotes traffic on the internal buses to the cores and their respective dedicated caches. As the number of cores “cross-snooping” to other cores increases and the number of snoops coming from external agents increases, the internal buses to the cores and their respective core caches can become significant. Moreover, because some of the snoops do not yield the requested data, they can promote unnecessary traffic on the internal buses.

The shared cache is a prior art attempt to reduce the traffic on internal buses to the cores and their respective dedicated caches, by including some or all of the data stored in each core's cache, thereby acting as an inclusive “filter” cache. Using a shared cache, snoops to cores from other cores or from external agents can first be serviced by the shared cache, thereby preventing some snoops from reaching the core caches. However, in order to maintain coherency between the shared cache and the core caches, accesses must be made to the core caches thereby negating some of the reduction in traffic on the internal buses promoted by the use of a shared cache. Furthermore, prior art multi-core processors that use a shared cache for cache filtering often experience latencies due to the operations that must take place between the shared and core caches to ensure shared cache coherency.

In order to help maintain coherency between a shared inclusive cache and corresponding core caches, various cache line states have been used in prior art multi-core processors. For example, in one prior art multi-core processor architecture, “MESI” cache line state information is maintained for each line of a shared inclusive cache. “MESI” is an acronym for four cache line states: “modified”, “exclusive”, “shared”, and “invalid”. “Modified”, typically means that the core cache line to which the shared “modified” cache line corresponds has been changed and therefore the shared cache no longer contains the most current version of the data. “Exclusive”, typically means that the cache line is to be only used (“owned”) by a particular core or external agent. “Shared”, typically means that the cache line may be used by any agent or core, and “invalid” typically means that the cache line not to be used by any agent or core.

Extended cache line state information has been used in some prior art multi-core processors in order to indicate separate cache line state information to the processor cores and agents within the computer system in which the processor resides. For example, “MS” state has been used in conjunction with a shared cache line to indicate that the line is modified with respect to external agents and shared with respect to processor cores. Similarly, “ES” has been used to indicate that the shared cache line is exclusively owned with respect to external agents and shared with respect to processor cores. Also, “Ml” has been used to indicate that a cache line is modified with respect to external agents and invalid with respect to processor cores.

Shared cache line state information and extended cache line state information, described above, have created new challenges in the effort to maintain cache coherency between shared cache and corresponding core caches while reducing snoop traffic on internal buses between the shared cache and cores. The problem is exacerbated as the number of processor cores and/or external agents increases and, therefore, the number of external agents and/or cores can be limited.

### BRIEF DESCRIPTION OF THE DRAWINGS

Embodiments of the invention are illustrated by way of example and not limitation in the figures of the accompanying drawings, in which like references indicate similar elements and in which:

FIG. 1 illustrates a prior art multi-core processor architecture.

FIG. 2 illustrates a number of shared inclusive cache lines including aspects of one embodiment of the invention

FIG. 3 has two tables indicating under what circumstances core bits may change during an inclusive shared cache look-up operation, according to one embodiment of the invention.

FIG. 4 is a flow diagram illustrating operations used in conjunction with at least one embodiment of the invention.

FIG. 5 is a table illustrating conditions in which a core snoop may be performed according to one embodiment of the invention.

FIG. 6 illustrates a front-side bus computer system in which at least one embodiment of the invention may be used.

FIG. 7 illustrates a point-to-point computer system in which at least one embodiment of the invention may be used

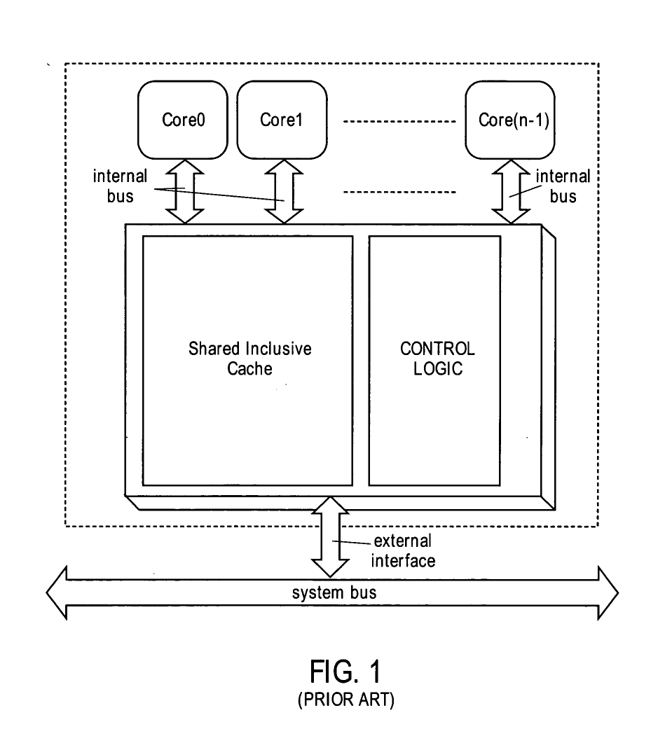

### DETAILED DESCRIPTION

Embodiments of the invention relate to caching architectures within microprocessors and/or computer systems. More particularly, embodiments of the invention relate to a technique to manage snoops within a processor having a number of processor core caches and an inclusive shared cache.

Embodiments of the invention can reduce the traffic on processor core internal buses by reducing the number of snoops from both external sources and other cores within a multi-core processor. In one embodiment, snoop traffic is reduced to cores by using a number of core bits associated with each line of an inclusive shared cache to indicate whether a particular core may contained the snooped data.

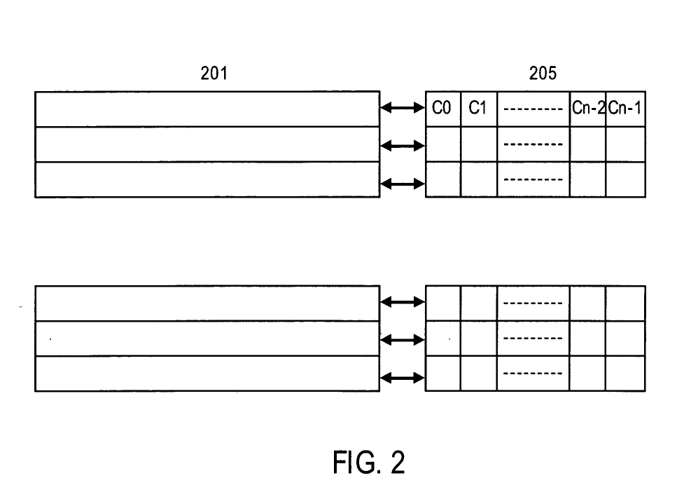

FIG. 2 illustrates a number of cache tag lines 201 within a shared inclusive cache having associated therewith an array of core bits 205 to indicate which core, if any, has a copy of the data corresponding to the cache tag. In the embodiment illustrated in FIG. 2, each core bit corresponds to a processor core within a multi-core processor and indicates which core(s) have the data corresponding to each cache tag. The core bits of FIG. 2, along with the MESI and extended MESI state of each line, function to provide a snoop filter that can reduce the snoop traffic seen by each processor core. For example, a shared inclusive cache line having an “S” state (shared) and core bits 1 and 0 (corresponding to two cores) may indicate that the core cache line corresponding to the 1 core bit may be in the “S” or “I” (invalid) state and therefore may or may not have the data. However, the core cache line corresponding to the 0 core bit is guaranteed not to have the requested data in its cache, and therefore no snoop to that core is necessary.

One embodiment of the invention addresses three generic circumstances which may affect accesses to processor core caches: 1) cache look-up, 2) cache fill, 3) snoops. Cache look-ups occur when either a processor core attempts to find data in the shared inclusive cache. Depending on the state of the shared cache line accessed and the type of access, a cache look-up may result in other cores' cache in the processor being accessed.

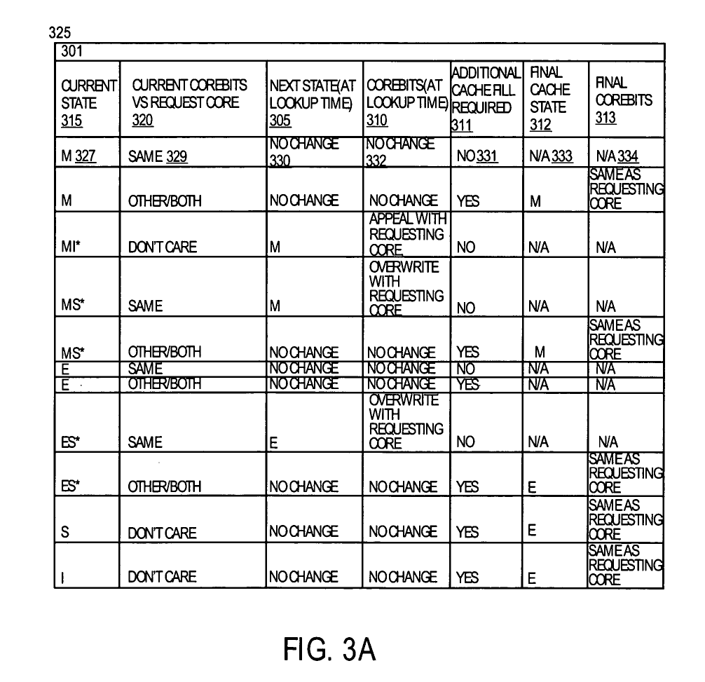

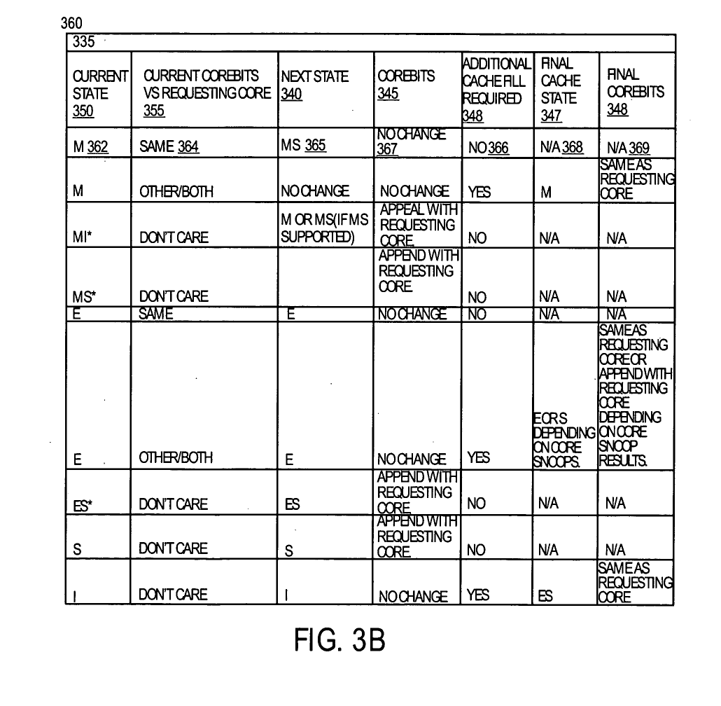

One embodiment of the invention uses core bits in conjunction with the state of the accessed shared cache line to reduce the traffic on core internal buses by eliminating one or more of the core caches as possible sources of the requested data. For example, FIG. 3 is a table illustrating current and next cache line states as a function of shared cache line state and core bits for two different types of cache look-ups; read-for-ownership access 301 and read line access 335. A read-for-ownership access is typically one in which the requesting agent is accessing cached data in order to gain exclusive control/access (“ownership”) to a cache line, whereas a line read is typically an operation in which a requesting agent is attempting actually retrieve data from the cache line and therefore can be shared among a number of agents.

In the case of read-for-ownership (RFO), illustrated in table 301 in FIG. 3, the result of the RFO operation has varying effects on the next state 305 of the accessed cache line as well as the next state core bits 310, depending upon the current cache line state 315 and the core to be accessed 320. In general, table 301 illustrates that if the current state in the shared inclusive cache line indicates that other core(s) may have the requested data, the core bits will reflect which core(s) may have the data in its core cache. Core bits, in at least one embodiment, prevent snooping every cores of a multi-core processor, thereby reducing traffic on the internal core buses.

However, if the requested shared cache line is owned or shared among cores, the core bits and cache states may not change during a cache look-up in one embodiment of the invention. For example, entry 325 of table 301 indicates that if the accessed shared cache line is in the modified state (“M”) 327, the shared cache line state will remain in the M state 330 and the core bits will not change 332. Instead, the cache look-up may generate a subsequent snoop and fill transaction, as indicated in column 311, and the requesting core may thereafter gain ownership of the line. The final cache line state 312 and core bits 313 may then be updated to reflect the newly acquired ownership of the line.

The remainder of table 301 indicates the next shared cache line state and core bits as a function of other shared cache line states as well as which cores will be accessed in response to an RFO operation. By reducing the accesses to the core caches depending on the shared cache line core bits during an RFO operation, at least one embodiment of the invention can reduce traffic on the internal core buses.

Similarly, table 335 illustrates the result of a read line (RL) operation on the next state 340 and core bits 345 of the accessed shared cache line during a cache line look-up operation as well as the cache line state and core bits after the shared cache line is filled by an access to a core cache. For example, entry 360 of table 335 indicates that if the accessed shared cache line is in the modified state (“M”)362 and the core bits reflect that the request core is the “same” 364 core that has the data, the next state core bits 367 and cache line state 365 can remain unchanged, because the core bits indicate that the request agent has exclusive ownership to the cache line. As a result, there is no need to snoop other cores' cache and therefore no cache line fill is necessary, indicated by column 366 and the final cache state 368 and core bit 369 values may remain unchanged.

The remainder of table 335 indicates the next shared cache line state and core bits as a function of other shared cache line states as well as which cores will be accessed in response to an RL operation. By reducing the accesses to the core caches depending on the shared cache line core bits during an RL operation, at least one embodiment of the invention can reduce traffic on the internal core buses.

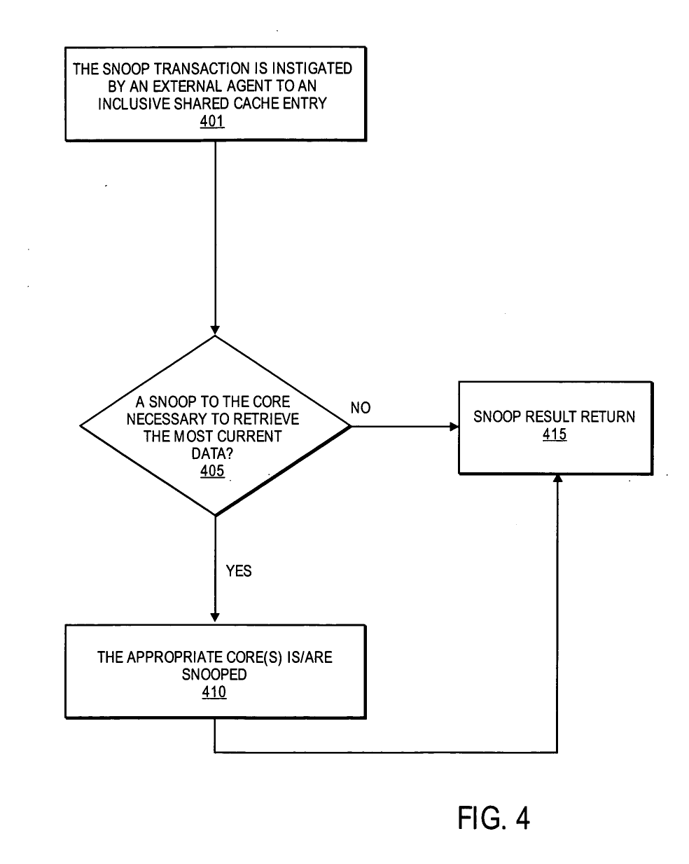

During a snoop transaction, embodiments of the invention can reduce traffic on the internal core buses by filtering out accesses to cores that will not result in the retrieval of the requested data. FIG. 4 is a flow diagram illustrating the operation of at least one embodiment in which core bits are used to filter core snoops. At operation 401, the snoop transaction is instigated by an external agent to an inclusive shared cache entry. Depending on the inclusive shared cache line state and the corresponding core bits, a snoop to the core may be necessary to retrieve the most current data at operation 405 or simply to invalidate the data in the core to obtain ownership. If a core snoop is necessary, the appropriate core(s) is/are snooped at operation 410 and the snoop result returned at operation 415. If no core snoops are necessary, the snoop result is returned from the inclusive shared cache at operation 415.

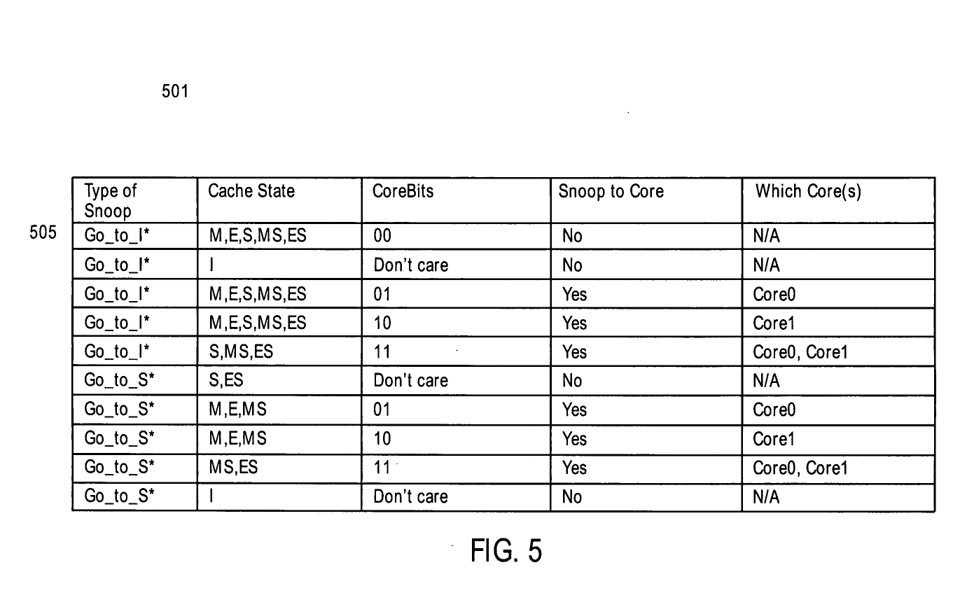

Whether a core snoop is performed in the embodiment illustrated by FIG. 4, depends upon the type of snoop, the inclusive shared cache line state, and the value of the core bits. FIG. 5 is a table 501 illustrating circumstances in which core snoops may be performed and which core(s) may be snooped as a result. In general, table 501 indicates that if the inclusive shared cache line is invalid or the core bits indicate that no core has the requested data, no core snoop is performed. Otherwise, core snoops may be performed based on the entries of table 501.

For example, entry 505 of table 501 indicates that if the snoop if a “go_to_l” type of snoop, meaning that the entry will go to the invalid state after the snoop, and the inclusive shared cache line entry is in either the M, E, S, MS, or ES state and at least one core bit is set to indicate that the data exists within a core cache, then the respective core is snooped. In the case of entry 505, the core bits indicate that core 1 does not have the data (indicated by a “0” core bit), therefore only core 0 is snooped, since it may in fact have the requested data (indicated by a “1” core bit). A “1” in the core bits of table 501 does not necessarily guarantee that the corresponding core cache will contain a current copy of requested data. However, a “0” indicates that the corresponding core is guaranteed not to have the requested data. No snoop may be issued to the core corresponding to a “0” core bit, thereby reducing traffic on the core's internal bus.

Although the embodiment illustrated in table 501 indicates that the multi-core processor has two cores (indicated by the two core bits), other embodiments may have more than two cores, and therefore more core bits. Furthermore, in other processors, other snoop types and/or cache line states may be used and therefore the circumstances in which the cores are snooped and which cores are snooped may change in other embodiments.

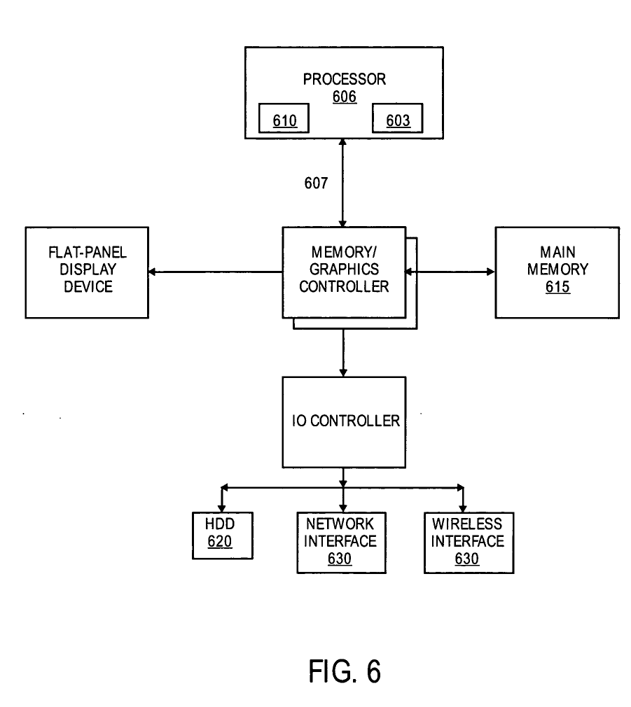

FIG. 6 illustrates a front-side-bus (FSB) computer system in which one embodiment of the invention may be used. A multi-core processor 605 accesses data from a core level one (L1) cache 603, shared inclusive level two (L2) cache memory 610 and main memory 615.

Illustrated within the processor of FIG. 6 is one embodiment of the invention 606. In some embodiments, the processor of FIG. 6 may be a multi-core processor. In other embodiments, the processor may be a single core processor within a multi-processor system. Still, in other embodiments the processor may be a multi-core processor in a multi-processor system.

The main memory may be implemented in various memory sources, such as dynamic random-access memory (DRAM), a hard disk drive (HDD) 620, or a memory source located remotely from the computer system via network interface 630 containing various storage devices and technologies. The cache memory may be located either within the processor or in close proximity to the processor, such as on the processor's local bus 607. Furthermore, the cache memory may contain relatively fast memory cells, such as a six-transistor (6T) cell, or other memory cell of approximately equal or faster access speed.

The computer system of FIG. 6 may be a point-to-point (PtP) network of bus agents, such as microprocessors, that communicate via bus signals dedicated to each agent on the PtP network. Within, or at least associated with, each bus agent is at least one embodiment of invention 606, such that store operations can be facilitated in an expeditious manner between the bus agents.

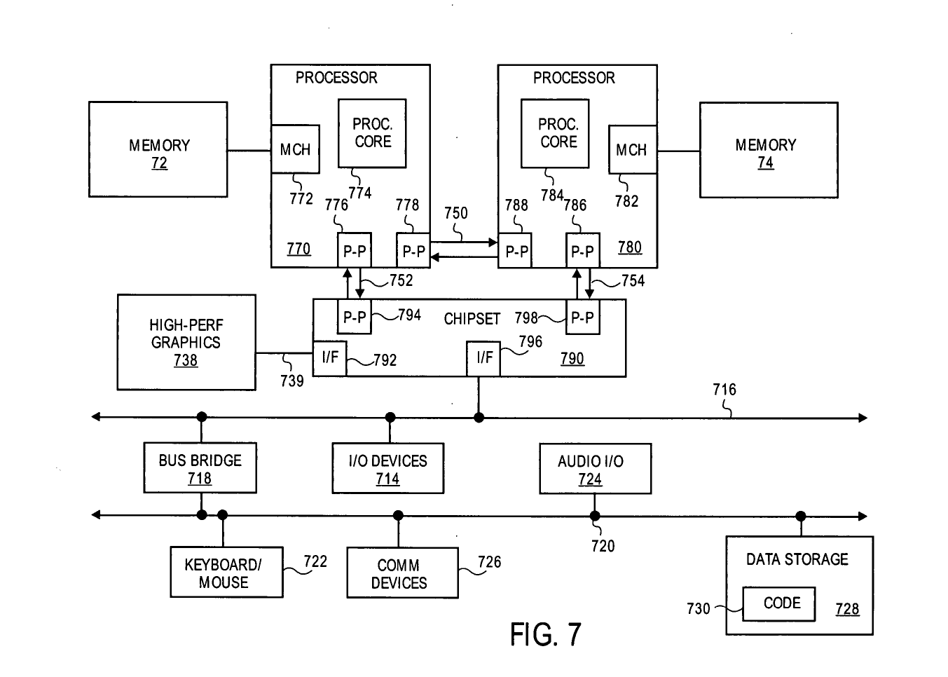

FIG. 7 illustrates a computer system that is arranged in a point-to-point (PtP) configuration. In particular, FIG. 7 shows a system where processors, memory, and input/output devices are interconnected by a number of point-to-point interfaces.

The system of FIG. 7 may also include several processors, of which only two, processors 770, 780 are shown for clarity. Processors 770, 780 may each include a local memory controller hub (MCH) 772, 782 to connect with memory 72, 74. Processors 770, 780 may exchange data via a point-to-point (PtP) interface 750 using PtP interface circuits 778, 788. Processors 770, 780 may each exchange data with a chipset 790 via individual PtP interfaces 752, 754 using point to point interface circuits 776, 794, 786, 798. Chipset 790 may also exchange data with a high-performance graphics circuit 638 via a high-performance graphics interface 739.

At least one embodiment of the invention may be located within the processors 770 and 780. Other embodiments of the invention, however, may exist in other circuits, logic units, or devices within the system of FIG. 7. Furthermore, other embodiments of the invention may be distributed throughout several circuits, logic units, or devices illustrated in FIG. 7.

Embodiments of the invention described herein may be implemented with circuits using complementary metal-oxide-semiconductor devices, or “hardware”, or using a set of instructions stored in a medium that when executed by a machine, such as a processor, perform operations associated with embodiments of the invention, or “software”. Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
an inclusive shared cache having an inclusive shared cache line and a core bit to indicate whether a processor core cache may have a copy of data stored within the inclusive shared cache line.

2. The apparatus of claim 1 wherein the core bit is to indicate whether the processor core cache is guaranteed not to have the copy of the data stored within the inclusive shared cache line.

3. The apparatus of claim 2 wherein whether a read-for-ownership (RFO) operation of the inclusive shared cache line will result in a change in the core bit depends upon a current state of the inclusive cache line and a current state of the core bit.

4. The apparatus of claim 3 wherein the current state of the inclusive cache line is chosen from a group consisting of: modified, modified-invalid, modified-shared, exclusive, exclusive-shared, shared, and invalid.

5. The apparatus of claim 2 wherein whether a read line (RL) operation of the inclusive shared cache line will result in a change in the core bit depends upon a current state of the inclusive cache line and a current state of the core bit.

6. The apparatus of claim 5 wherein the current state of the inclusive cache line is chosen from a group consisting of: modified, modified-invalid, modified-shared, exclusive, exclusive-shared, shared, and invalid.

7. The apparatus of claim 2 wherein a cache fill of the inclusive shared cache line will cause a processor core bit to change to reflect the core to which the cache fill corresponds.

8. A system comprising:
a processor having a plurality of cores, each of the plurality of cores having a dedicated core cache;
an inclusive shared cache to store a copy of all of the data stored in the plurality of core caches, each line of the inclusive shared cache corresponding to a plurality of core bits to indicate which of the plurality of core caches may have a copy of data stored in the inclusive share cache line to which the plurality of core bits correspond.

9. The system of claim 8 wherein the plurality of core bits are to indicate which of the plurality of core caches are guaranteed to not contain a copy of the data.

10. The system of claim 9 wherein the core bits are to indicate whether a snoop transaction from an agent external to the inclusive shared cache is to result in a snoop to any of the plurality of processor core caches.

11. The system of claim 10 wherein whether a snoop transaction from the external agent is to result in a snoop to any of the plurality of processor core caches further depends upon the type of snoop transaction and the state of an inclusive shared cache line that is snooped by the external agent.

12. The system of claim 11 wherein the state of the inclusive shared cache line that is snooped is chosen from a group consisting of: modified, exclusive, shared, invalid, modified-shared, and exclusive-shared.

13. The system of claim 12 wherein the plurality of core caches are level-1 (L1) caches and the inclusive shared cache is a level-2 (L2) cache.

14. The system of claim 13 wherein the external agent is an external processor coupled to the processor by a front-side bus.

15. The system of claim 13 wherein the external agent is an external processor coupled to the processor by a point-to-point interface.

16. A method comprising:
initiating an access to a first cache;
initiating an access to a second cache depending upon the state of a set of bits to indicate whether the second cache may contain a copy of data stored in the first cache;
retrieving a copy of the data as a result of one of the accesses.

17. The method of claim 16 wherein if the access to the first cache indicates an invalid cache line state an access is initiated to the second cache regardless of the state of the set of bits.

18. The method of claim 17 wherein the set of bits corresponds to a plurality of processor cores.

19. The method of claim 18 wherein if the set of bits contains a first value in an entry corresponding to the second cache, the second cache is guaranteed not to contain a copy of the data.

20. The method of claim 19 wherein if the set of bits contains a second value in the entry corresponding to the second cache, the second cache may be accessed depending on a plurality of states corresponding to a cache line access to the first cache.

21. The method of claim 20 wherein the first cache is an inclusive shared cache containing the same data of the second cache.

22. The method of claim 21 wherein the second cache is a core cache to be accessed by at least one of the plurality of processor cores.

23. The method of claim 22 wherein the accesses to the first and second caches are snoop transactions.

24. The method of claim 22 wherein the accesses to the first and second caches are cache look-up transactions.

25. A multiple core processor comprising:
a processor core;
a processor core cache coupled to the processor core;
a system bus interface;
an inclusive shared cache having an inclusive shared cache line and a first means for indicating whether the processor core cache is guaranteed not to have the copy of data stored within the inclusive shared cache line.

26. The apparatus of claim 25 wherein whether a read-for-ownership (RFO) operation of the inclusive shared cache line will cause the first means to change state depends upon a current state of the inclusive cache line and a current state of the first means.

27. The apparatus of claim 26 wherein the current state of the inclusive cache line is chosen from a group consisting of: modified, modified-invalid, modified-shared, exclusive, exclusive-shared, shared, and invalid.

28. The apparatus of claim 27 wherein whether a read line (RL) operation of the inclusive shared cache line will cause the first means to change state depends upon a current state of the inclusive cache line and a current state of the first means.

29. The apparatus of claim 28 wherein the current state of the inclusive cache line is chosen from a group consisting of: modified, modified-invalid, modified-shared, exclusive, exclusive-shared, shared, and invalid.

30. The apparatus of claim 29 wherein a cache fill of the inclusive shared cache line is to cause the first means to change state to reflect the core to which the cache fill corresponds.
